(19) United States
(12) Patent Application Publication
(10) Pub. No.: US 2012/0174871 A1
(43) Pub. Date: Jul. 12, 2012

(54) AQUATIC TANK

(76) Inventor: Spencer Grabois, Golden Beach, FL (US)

(21) Appl. No.: 12/986,817

(22) Filed: Jan. 7, 2011

(51) Int. Cl. A01K 63/06; A01K 63/00

(52) U.S. Cl. 119/265; 119/267; 119/269

(57) ABSTRACT

An aquatic tank comprising a housing shaped or otherwise configured to represent an animate object is presented. Furthermore, the housing comprises a body with a display area, and a removably disposed upper head portion. A container is disposed within body of the housing and is viewable through the display area. The apparatus also comprises a lid removably disposed relative to the container in order to allow at least temporary access into said interior portion thereof. The apparatus further comprises a plurality of elongated access channels disposed within the housing in a manner such that the access channels are fluidically connected to the interior portion of the container in order to facilitate feeding, breathing, and/or draining or other maintenance. A lighting assembly is disposed in an illuminating relation with the container such that the apparatus may be used as a night-light or other soothing accent.

### BACKGROUND OF THE INVENTION

### Field of the Invention

The present invention is generally directed to an aquatic tank which, in at least one embodiment, comprises a housing generally representative of or otherwise shaped to resemble a fictional, non-fictional, fantasy, mythical or realistic animate object or character. As will be described below, the animate object may include, for example, a teddy bear, cartoon or comic-strip character, dragon, college or university mascot, professional, holiday figure, a living or deceased athlete, actor/actress, president, a plant, tree, or other organic or botanical organism, etc. In particular, the enclosure comprises a movable and/or removable lid in order to provide access to the aquatic tank or other container such as for cleaning or other maintenance. The enclosure further comprises one or more channels such as a feeding tube, air or breathing tube, or drainage tube disposed in a communicative relation with the aquatic tank. As will be apparent from the disclosure herein, the aquatic tank and/or the living creature therein is viewable via one or more display or viewing areas, which in a preferred embodiment is disposed at or proximate a midsection, for example, in the stomach area of the teddy bear or other representative animate object and/or figure.

### DESCRIPTION OF THE RELATED ART

Aquariums and aquatic tanks which are designed to house one or more water-dwelling plants or animals are generally common in households as decorative features, and the animals are commonly kept and raised as pets. Many aquariums consist of square, rectangular, round or other geometric shape and may, in some instances, be unsightly.

There is a need in the art for an aquatic tank that is aesthetically pleasing, soothing, and can be used as a relaxing gift to a child, a loved one, and/or to an individual in a hospital or recovering from an illness or injury, for example. In particular, the proposed apparatus will comprise a housing generally shaped to resemble an animate object, including, but certainly not limited to a teddy bear, and further comprises a interior illuminating assembly which may be used as a night light to create soothing ambiance, mood and/or environment. The apparatus will further include one or more access channels and a movable or removable lid in order to facilitate feeding, breathing, and maintenance.

### SUMMARY OF THE INVENTION

The present invention is directed to an aquatic tank comprising a housing which is shaped or otherwise structured to resemble an animate object. As described herein, the animate object may be a teddy bear, a baby, dragon, witch, super hero, or other fictional, non-fictional and/or fantasy character, etc. The animate object shaped housing may also comprise a plant including a tree or flower.

In any event, the apparatus of the present invention comprises an aquatic tank or container which is at least partially embedded or disposed within the housing and viewable via a display area or window. The container may house one or more plants or animals and in at least one embodiment is preferably structured to house aquatic life.

As will be described below in greater detail, the various embodiments of the present invention further comprise one or more access channels, such as a feeding tube, breathing tube, and/or drainage tube. The access channels essentially function as conduits into the container and/or are otherwise disposed in a communicative relation with the interior portion of the container and extend through the interior of the housing. The access channel(s) preferably end at or proximate the outer portion of the housing such as, for example, at or near the object's mouth. Feeding of the fish or other animal within the tank is thus accomplished by disposing food particles into an access channel as if the user were feeding the teddy bear or other animate object. It should be noted, however, that the access channel(s) of at least one embodiment may end at a location within the housing, such that it can be accessed by, for example, tilting the head back, removing the head, opening the mouth, etc.

As will be discussed in greater detail below, at least one embodiment of the present invention further comprises a lighting assembly disposed in an illuminating relation with the container. The lighting assembly may comprise a low-heat or no-heat light emitting diode (LED). Certain embodiments of the housing comprise a plush material, which may be flammable or burned when exposed to excessive amounts of heat. Accordingly, the lighting assembly of the present invention is structured, configured, and positioned to eliminate or reduce the occurrence of safety hazards such as fires. In addition, with the lighting assembly, the apparatus of the present invention may be utilized as a soothing night light, or other accent to a house or room.

Other structural and operative features of the present invention include a camera, microphone, and/or audio-visual recorder, image capturing device, etc. In such an embodiment, the apparatus disclosed herein may be used as a monitoring device, security camera, baby listening device, etc.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a front elevation view of the aquatic tank disclosed in accordance with at least one embodiment of the present invention.

FIG. 2 is a front elevation view of the container illustrated in the embodiment shown in FIG. 1.

FIG. 3 is a partially exploded view of the aquatic tank illustrated in FIG. 1.

FIG. 4 is a bottom view of the upper portion of the housing illustrated in FIGS. 1 and 3.

FIG. 5 is a schematic representation of an access channel as disclosed in accordance with at least one embodiment of the present invention.

FIG. 6 is a front elevation view of the upper portion of the housing as disclosed in accordance with another embodiment of the present invention.

FIG. 7 is a front view of a container and lid disposed in an open orientation as disclosed in accordance with yet another embodiment of the present invention.

FIG. 8 is a front view of the container and lid shown in FIG. 7 disposed in a closed orientation.

FIG. 9 is a partial side view of the aquatic tank of at least one embodiment comprising a drainage assembly.

Like reference numerals refer to like parts throughout the several views of the drawings.

### DETAILED DESCRIPTION OF THE PREFERRED EMBODIMENT

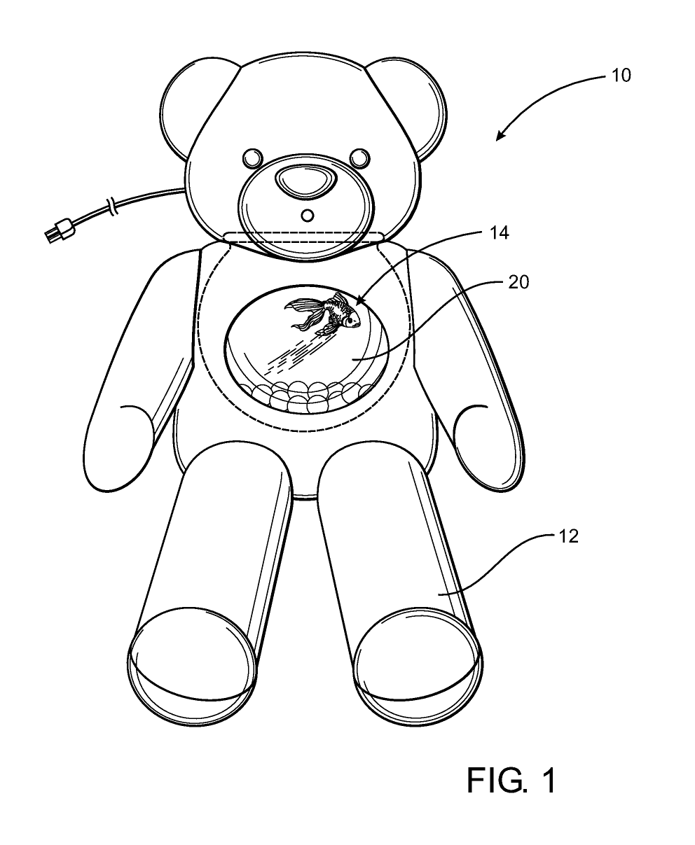

As shown in the accompanying drawings, and with particular reference to FIG. 1, the present invention is directed to an aquatic tank shaped as an animate object, generally referenced at 10. In particular, the aquatic tank 10 of the various embodiments of the present invention comprises a housing 12 cooperatively structured and configured to at least partially house, enclose and/or support a tank or container 20 such as an aquarium disposed therein. The housing 12 of at least one embodiment is structured and/or configured to be representative of or otherwise shaped to simulate an animate object or character. As generally represented in the embodiment shown in the figures, the animate object of at least one embodiment may comprise a teddy bear or other stuffed animal or toy. However, the housing 12 may be structured to resemble virtually any animate object which comprises any fictional, non-fictional, fantasy, mythical, and/or realistic object, or character, including but in no manner limited to a cartoon or comic-strip character, dragon, college or university mascot, a living or deceased athlete, actor/actress, or president, a plant, tree, or other organic or botanical organism, etc.

Furthermore, the housing 12 of at least one embodiment comprises a substantially plush material such as that commonly used for stuffed animals or stuffed toys. For instance, the plush material may comprise one or more fabrics or textile materials such as cotton, wool, polyester, silk, and/or other natural or synthetic fiber(s). Of course, the housing 12 may comprise virtually any material, and may be a hard or soft plastic, aluminum, metal, etc.

More in particular, the housing 12 of various embodiments of the present invention comprises at least one display area or display window 14 disposed on a predetermined portion thereof. For exemplary purposes only, the display area 14 may comprise a removed, or otherwise open area of the housing 12 through which the container 20 is viewable from a position exterior to the housing 12. Specifically, the container 20 may protrude slightly though the display area 14 and bulge outward toward the exterior of the housing 12. In another embodiment, however, the display area or window 14 comprises a transparent or translucent pane or shield through which the container 20 is viewable.

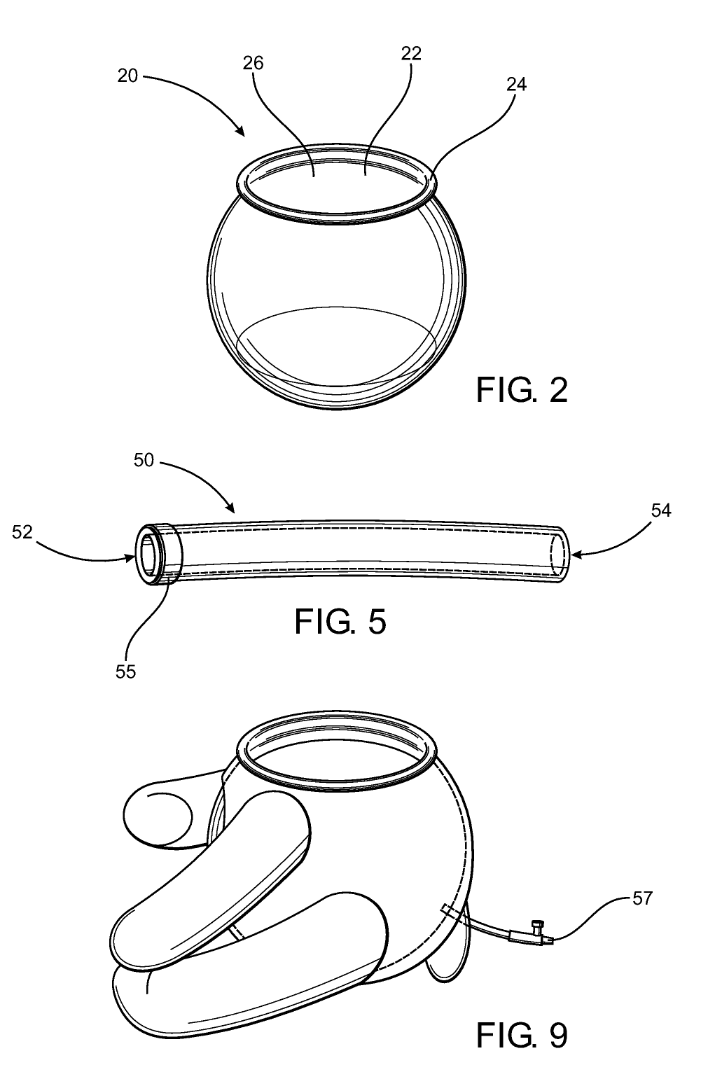

Referring now to FIG. 2, the container 20 of at least one embodiment comprises an aquatic tank, bowl, or other structure having an at least partially hollow interior portion 22 which is cooperatively dimensioned, structured and configured to house a living creature, such as an aquatic or other animal including a fish, turtle, snail, etc. The container 20 of the various embodiments may be of virtually any size and may be configured to house fresh or salt water environments including the various different fish, animals, or other living creatures therein. The container 20 illustrated in FIG. 2 is merely representative of at least one embodiment, and thus the container 20 of other embodiments may comprise a different shape, size and/or configuration. The container 20 of the various embodiments is preferably made of plastic, glass or acrylic, and may, in at least one embodiment, be shatter proof or not easily breakable. As will be discussed in greater detail below, and as generally representative in FIG. 2, the container 20 of at least one embodiment comprises a peripheral edge 24 disposed around an upper, open portion 26 thereof. The peripheral edge 24 is cooperatively structured to telescopically connect, engage or abut with a similar peripheral lip disposed on a movable or removable lid 30.

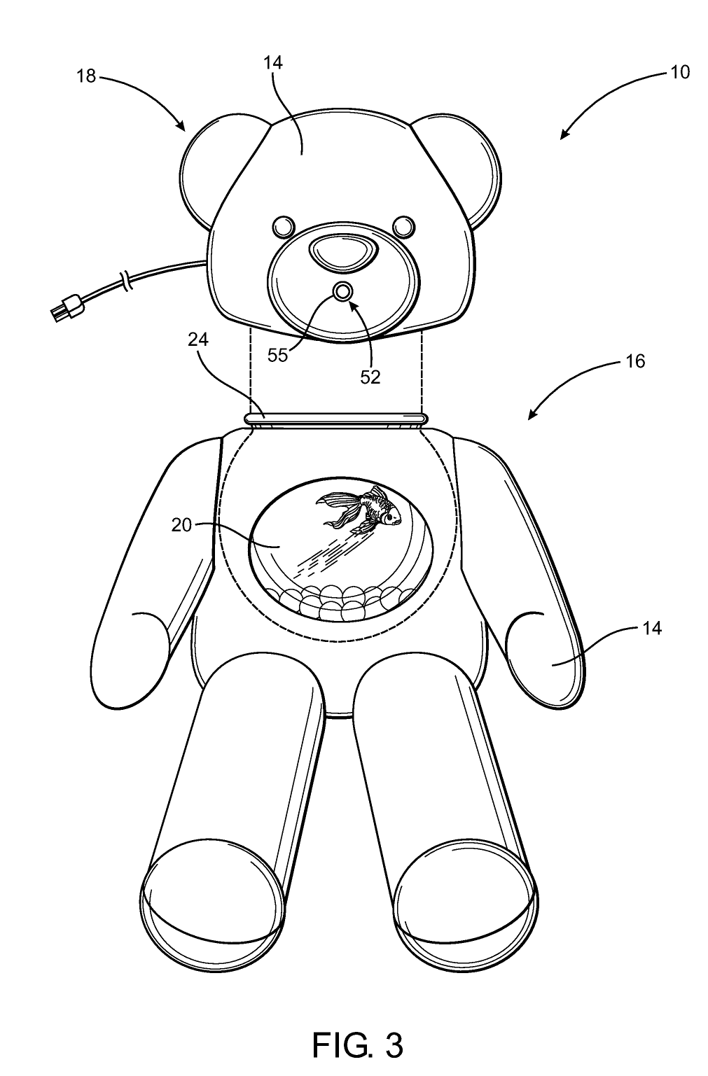

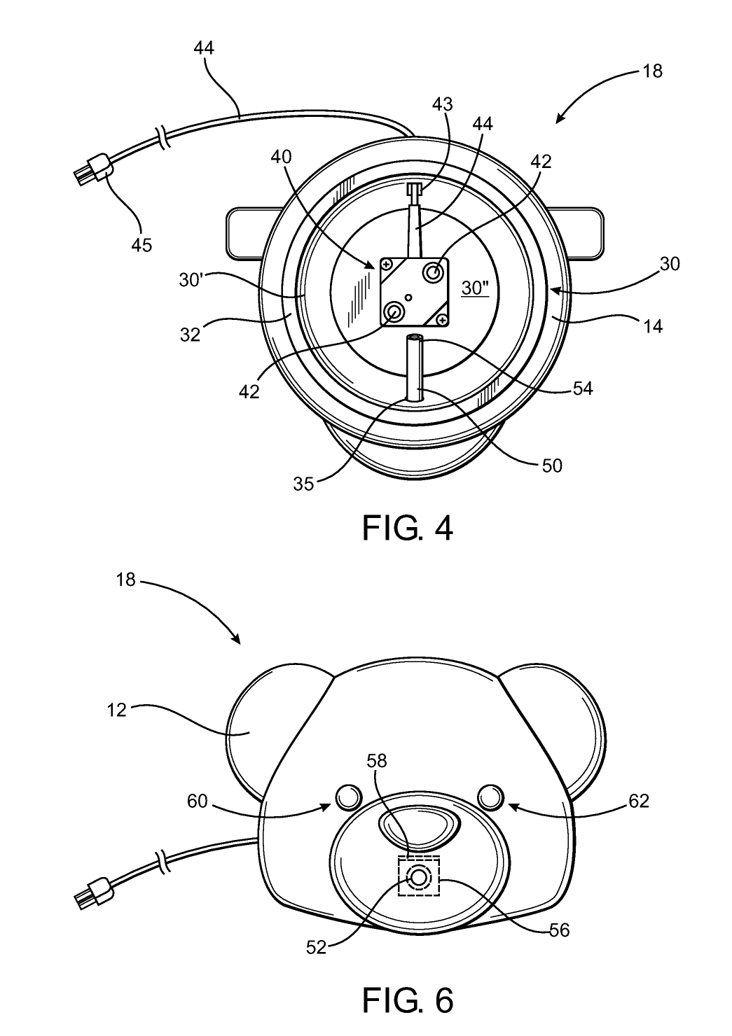

As illustrated in the exploded view of FIG. 3, the housing 14 of at least one embodiment comprises a body portion 16 and a removably disposed upper portion or head 18. While the embodiment of FIG. 3 illustrates that the upper portion or head 18 is completely removable and/or separable from body portion 16, in yet another embodiment, the upper portion 18 may be movably disposed relative to the body portion 16, for instance, pivotal via a hinge or other similar pivoting or sliding mechanism connected therebetween. Specifically, the lid 30 (illustrated in the bottom view of the head portion 18 of FIG. 4) is disposable in an at least partially removable relation to the container 20 in order to provide temporary access into the interior portion 22 thereof. For instance, the lid 30 may be completely removable or disposed in a pivotal, sliding, or other movable relation to the container 20 so as to provide access into the container 20 for maintenance, cleaning, etc. As shown in the inside or bottom view of the upper portion 18 illustrated in FIG. 4, the lid 30 of at least one embodiment is embedded within or otherwise connected to a bottom end of the upper portion 18 of the housing 14. In such an embodiment, removal of the upper portion 18 from the body portion 16 serves to also simultaneously remove the lid 30 from the container 20.

In addition, the lid 30 may connect to or engage the container in a number of different ways so as to facilitate the practice of the present invention in the intended manner. For instance, the lid 30 of at least one embodiment comprises a peripheral lip 32 such as a step or groove which is cooperatively structured to be disposed in an overlapping and/or telescopic relation with the cooperatively disposed peripheral edge 24 of the container 20. The lip 32 and edge 24 of at least one embodiment may be loosely connected or engaged to one another such that if a passerby or user accidentally bumps, nudges, or collides with the upper portion 18 and/or the table or supporting surface on which the present invention is disposed, the upper portion 18 and lid 30 are structured to disconnect from the body 16 and container 20, respectively, without the body 16 and container 20 falling over. In the embodiment where the lid 30 is movable, slidingly engaged or pivotal relative to the container, the upper portion 18 and lid 30 is structured to slide, pivot or otherwise easily move in the event of inadvertent or accidental contact. Such a feature serves to eliminate or minimize accidental spilling of the contents of the container 20. However, in another embodiment, the lid 30 and container 20 may be securely engaged with one another, for example, via a plurality of cooperatively disposed notches and grooves, clips, tabs, and/or with threaded grooves to facilitate a screw-top.

As also illustrated in FIG. 4, the present invention further comprises a lighting assembly 40. The lighting assembly 40 of the various embodiments is operatively disposed in an illuminating relation with the interior portion 22 of the housing 20. For instance, as shown in the embodiment of FIG. 4, the lighting assembly 40 is connected to an undersurface or inside portion 30′ of the lid 30 such that when the lighting assembly is turned on or activated and the lid 30 is operatively connected to the container 20, one or more lights serve to illuminate the interior portion 22 of the container 20. More in particular, the lighting assembly 40 may be securely fastened to the inside portion 30′ of the lid 30 via one or more screws and/or a supporting plate 30″, which may comprise wood, plastic or other structures capable of facilitating the mounting of the lighting assembly 40. Moreover, at least one embodiment of the lighting assembly 40 comprises one or more low-voltage, low heat light emitting diodes (LEDs) 42 capable of emitting light into the container 20. Of course, other lighting structures may be used such as light bulbs, halogen bulbs, fluorescent lights, etc. In addition, the lighting assembly 40 may comprise multiple colors, changing colors, flashing lights, etc.

In any event, the lighting assembly 40 of the various embodiments is connected to or otherwise comprises a power source, which may be in the form of one or more replaceable batteries. However, as also illustrated in FIG. 4, the lighting assembly 40 of at least one embodiment comprises a power cord or cable 44. As illustrated, the power cord 44 is disposed through the lid 30 and upper portion 18, such as via cooperatively structured and disposed opening 43. The opposite end of the power cable comprises a coupling device or plug 45 connectable to a power source, such as a wall outlet. In such an embodiment, the lighting assembly 40 is preferably, but not necessarily, disposed on or connected to the lid 30 or upper portion 18 such that if an individual or passerby accidentally trips on or pulls the power cord 44, the lid 30 and upper portion 18 will disconnect or disengage from the container 20 and body 16 respectively, without having the container 20 tip over and spill.

In particular, and still referring to FIG. 4, opening 43 through which the LED or other lighting assembly cord 44 is disposed may be of a larger dimension than the cord 44. Thus, the opening 43 of at least one embodiment is structured to facilitate the flow of air or oxygen into the lid 30 and into the container 20, such as through the unoccupied space around cord 43.

In a preferred embodiment, the lighting assembly 40 is disposed between one and twelve inches above the water level in the container 20. However, the lighting assembly 40 need not be disposed within the lid 30 or even above the water level, and may instead be virtually anywhere within the body 16 or upper portion 18 so long as it is disposed in an illuminating relation with the container 20. For example, the lighting assembly 40 may be disposed on one or more of the sides of the container 20, beneath the container 20, etc.

The various embodiments of the present invention further comprise one or more access channels 50 disposed at least partially within the housing 12 and being further fluidically or otherwise communicatively connected between the interior portion 22 of the container 20 and an exterior of the housing 12. For instance, the one or more access channels 50 are structured to provide a way to easily feed the fish or other living creature disposed within the container 20. Accordingly, the access channel 50 of at least one embodiment comprises a tube having a sufficient dimension and circumference structured to transfer food or other substance into the container 20.

Accordingly, the access channel(s) 50 comprises a first accessible end 52 disposed at or proximate an outer surface of the housing 12 and in an accessible relation to the user. For instance, as illustrated in FIG. 3, the first end 52 is disposed at or near the teddy bear's mouth and is always open and accessible. Referring again to FIG. 4, the second end 54 of the access channel 50 of at least one embodiment is disposed at or near the lid 30. Thus, when the lid 30 is connected to the container 20, the access channel 50 is thereby disposed in a fluid or other communicative relation with the interior portion 22 of the container 20. For instance, the access channel 50 may be disposed at least partially through the lid 30, such as through a cooperatively structured and disposed opening 35, and into the fluid or accessible relation with the interior portion 22 of the container 20. More in particular, the first end 52 of the access channel 50 of at least one embodiment is preferably disposed at an elevation above the second end 54 such that any food or other particle or substance, such a water conditioner, medication, etc., is transferred though the access channel 50 by virtue of gravitational force and/or a small amount of applied force from the user.

In yet another embodiment, one or more of the access channels 50 are structured and configured to define a substantially continuous path for a flow of air to travel between the exterior of the housing and the interior portion 22 of the container 20 in order to supply oxygen to the living creature or otherwise into the interior portion 22 of the container 20. In such a case, the first end 52 may but need not be disposed at an elevation above the second end 54. Furthermore, such an access channel(s) 50, which is preferably always open in order to continuously supply or circulate air or oxygen into the interior portion 22 of the container 20, may thus comprise a screen or filter at one or more ends and/or along the length thereof in order to keep unwanted debris or materials out of the container 20. The screen of at least one embodiment comprises a mesh-like material or structure disposed within the channel 50.

Accordingly, in a preferred embodiment of the present invention, one access channel or tube 50 is disposed or otherwise accessible at or near the object's mouth and second access channel or tube 50 is disposed or otherwise accessible at the top of the object's head 18. The access channel 50 disposed at or near the top or peak of the object's head creates a substantially straight conduit into the container 20 and is ideal for disposing food particles there though without the particles being lodged or otherwise stuck in the tube. The two access channels 50 also provide a sufficient amount of oxygen to the fish or other creature in the container 20. It should be noted, however, that the access channels 50 may be disposed at other locations on or around the object and further, additional access channels 50 may be added to provide additional flow of oxygen or additional locations to feed the living creatures.

As best illustrated in FIGS. 3 and 5, at least one embodiment of the present invention further comprises a cap or ring 55, such as a grommet ring, disposed on the end of the access channel or tube 50. The ring 55 of at least one embodiment comprises a metallic or plastic grommet cap which is structured to easily identify the access channel or tube 50 to a user. For instance, the ring(s) 55 may be color coded and structured to identify whether the particular access channel 50 is a feeding tube, air tube, drainage tube, etc. Further, the end cap or ring 55 of at least one embodiment may also be configured or structured to maintain the end 52 of access channel 50 in its operative position, such as, for example, at or near the object's mouth region. For example, with the added ring 55, the end 52 of the access channel 50 may create a tight fit around the periphery thereof, thereby minimizing inadvertent recession or sinking of the end 52 into the housing 12.

Furthermore, as illustrated in FIG. 6, in at least one embodiment, one or more of the access channels 50 comprises a closure mechanism 56 disposed at or near an end 52 thereof. For instance, the closure mechanism 56 is structured to selectively dispose the end 52 of the access channel 50 between an open orientation and a closed orientation. For instance, the closure mechanism 56 of at least one embodiment comprises a movable or removable end cap, plug, flap and/or stop. As illustrated in FIG. 6, the closure mechanism 56 comprises a pivotal flap connected to the housing 12 via a hinge 58 which may be in the form of a living hinge, stitches, adhesive, etc. disposed on a side or end of the closure mechanism 56 which allows the flap or mechanism 56 to selectively pivot into and out of an open and closed orientation. In any event, the closure mechanism 56 may comprise a plush material, textile material, plastic, metal, or virtually any material structured to facilitate the practice of the present invention in the intended manner

Specifically, the closure mechanism 56 as illustrated in FIG. 6 is structured to keep unwanted debris or material out of the container 20 and can be selectively opened for a user to dispose food or other substance into the first end 52 thereof. As described above, the food or other substance will then travel through the access channel 50 via gravitational force and into the interior portion 22 of the container 20.

As discussed above, the various embodiments of the present invention may comprise any number of access channels 50, each comprising a first end 52 disposed at or proximate different locations of the housing 12. For instance, at least one embodiment comprises an access channel 50 or “feeding tube” accessible via a first end 52 disposed in a facial region of the housing 12, for instance at or near the animate object's mouth, nose, etc. The feeding tube may but need not comprise a selectively disposable closure mechanism 56 as disclosed above. In addition to or instead of the feeding tube, at least one embodiment comprises an access channel 50 or “breathing tube” having a first end 52 disposed at the rear of the housing 12, for instance, at the back of the animate object's head. The breathing tube is preferably always open and may, but need not comprise a filter or screen as disclosed above.

Moreover, as illustrated in FIG. 9, at least one embodiment of the present invention comprises one or more drainage tubes or assemblies 57 disposed in a fluidically communicative relation with the interior portion of the container 20. For instance, the drainage tube 57 comprises a first end connected to the container 20, such as at or near the bottom of the container 20, and a second end exiting the housing 12, preferably at a position lower than the first end thereof. In addition, the drainage tube 57 comprises one or more valves 57′, such as a ball valve, screw valve or other tight seal that is disposable between an open and a closed orientation. Accordingly, with the valve 57′ selectively disposed in the “open” position, the drainage tube 57 may be used to easily and efficiently drain the water or other fluid content of the container 20. With the valve 57′ selectively disposed in the “closed” orientation, water or other fluid or contents may be disposed into and remain within the container 20.

Moreover, a picture frame assembly may be mounted on at least one side or a back portion of the container 20 such that a picture, photograph, artwork or other visually appealing item may be disposed therein. In particular, when viewing the container 20 through display window 14, the picture frame assembly may be disposed on the opposite side or backend of the container 20 such that a picture or other object disposed therein is viewable through the container 20.

Additionally, one or more embodiments of the present invention further include an audiovisual monitoring device, timer, alarm, recording device, or other technological enhancements, generally represented as 60. For instance, an audiovisual monitoring device 60, such as a video camera, still camera, microphone, or speaker may be embedded into the housing 12 and configured to monitor the environment external to the housing 12. Although the device 60 is illustrated in FIG. 6 as being disposed at or near the objects eyes, the device 60 may be embedded or disposed virtually anywhere on the aquatic tank 10 of the present invention, including, but not limited to the lid 30, housing 12, etc. In such an embodiment, the apparatus 10 of the present invention may be utilized as a baby monitor, security camera, or other recording and/or transmitting device. The apparatus 10 of at least one embodiment further comprises a local memory device structured to record and store the visual and audio data. It is also contemplated that the apparatus further comprises a transmitter through which the data may be communicated to a remote location, such as via a short range local network including Bluetooth or via the Internet or other networks. In addition, the present invention may comprise a timer, alarm or other indicator 62 which is configured to periodically emit a signal representative of a feeding time for the living creature disposed within the container 20. As represented in FIG. 6, the indicator 62 is embedded or disposed within the object's eye, however, it may be disposed anywhere on or within the housing 12. Particularly, the indicator 62 may comprise a visual indicator, such as a flashing light, colored light, etc., or an audible indicator, such as a beep or chime.

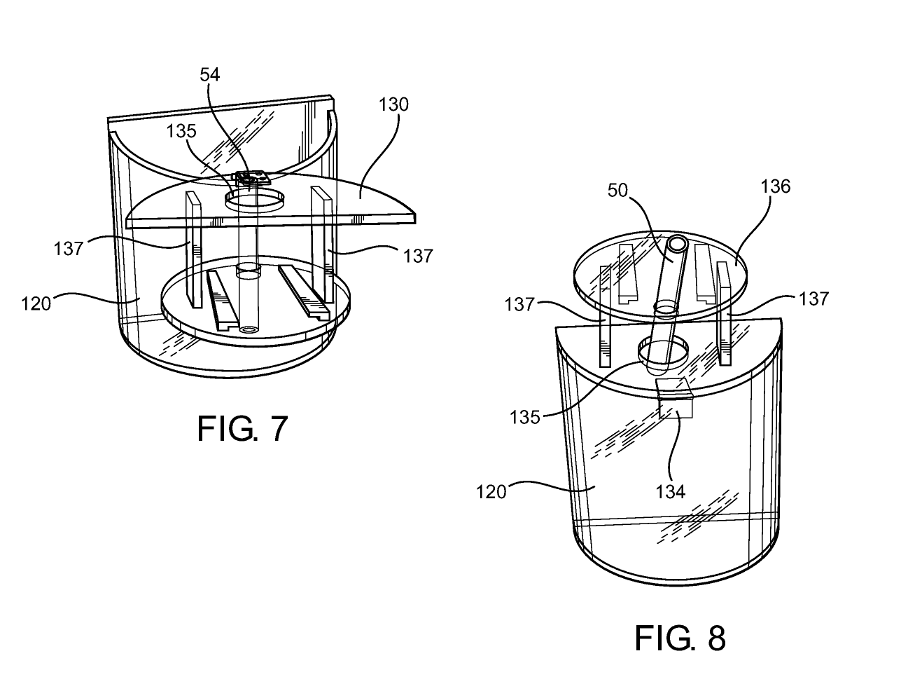

Additional structural variations to the container 120 and lid 130 are illustrated in the embodiment shown in FIGS. 7 and 8. In particular, the lid 130 of the illustrated embodiment is movably disposed relative to the container 120 by virtue of a pivoting hinge 134 connected therebetween. Accordingly, the lid 130 is disposable between an open orientation (illustrated in FIG. 7) and a closed orientation (illustrated in FIG. 8) by movably disposing or pivoting the lid 130 open. In at least one embodiment, the housing 12 (not shown in FIGS. 7 and 8) also pivots open wherein the lid 130 is connected to or otherwise disposed within upper portion 18 and the container 120 is disposed within body 16.

Furthermore, lid 130 of at least one embodiment comprises an opening 135 through which a cooperatively structured access channel or tube 50 is disposed. Accordingly, access channel 50 is positioned in a fluidically or other communicative relation with the interior portion 22 of container 20 in order to facilitate disposition of food or other particles therein, in order to create a substantially continuous path of air or oxygen therein, and/or in order to provide an efficient way to drain water from within the container 120, similar to the embodiment described in detail above. Moreover, the opening 135 may comprise a dimension larger than the circumference or area of the corresponding access channel 50 in order to further facilitate circulation or disposition of air or oxygen in the container 120.

In addition, and still referring to FIGS. 7 and 8, the present invention further comprises an upper shield and/or support structure 136 secured in a spaced relation to the corresponding lid 130, for example, via one or more supporting legs 137. In particular, upper shield member 136 is structured to prevent or minimize the amount of unwanted material or objects being deposited within the container 120, including, for example, stuffing, hair, stray threads, etc. In addition, upper shield member 136 comprises a mounting assembly, such as receiving channels 140, which are structured to engage or sliding receive a cooperatively structured lighting assembly. As above, the lighting assembly of at least one embodiment comprises one or more low-heat LEDs for purposes of safety.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. An aquatic tank comprising:
a housing,
said housing comprising at least one display area disposed on a predetermined portion thereof,
a container disposed at least partially within said housing and being viewable through said at least one display area,
said container comprising an least partially hollow interior portion dimensioned and configured to house a living creature,
a lid disposed in an at least partially removable relation to said container to provide temporary access into said interior portion thereof, and
at least one elongated access channel disposed at least partially within said housing, said access channel being disposed in a communicative relation with said interior portion of said container.

2. The aquatic tank as recited in claim 1 further comprising a plurality of elongated access channels each communicatively disposed between said interior portion of said container and an exterior of said housing.

3. The aquatic tank as recited in claim 2 wherein at least one of said plurality of access channels comprises a closure mechanism disposed at an end thereof; said closure mechanism being structured to dispose said end of said access channel between an open orientation and a closed orientation.

4. The aquatic tank as recited in claim 2 further comprising a ring disposed around a peripheral edge of a proximate end of at least one of said plurality of access channels.

5. The aquatic tank as recited in claim 2 wherein at least one of said plurality of access channels comprises a feeding tube structured to facilitate disposition of food particles there through and into said container.

6. The aquatic tank as recited in claim 5 wherein at least one of said plurality of access channels is structured and configured to define a substantially continuous path for a flow of air to travel between said interior portion of said container and the exterior of said housing.

7. The aquatic tank as recited in claim 6 wherein at least one of said plurality of access channels comprises a drainage tube; said drainage tube comprising a first end connected to said container.

8. The aquatic tank as recited in claim 7 wherein said drainage tube further comprises a second end exteriorly disposed relative to said housing.

9. The aquatic tank as recited in claim 7 wherein said drainage tube further comprises at least one valve connected thereto; said valve being disposable between an open and a closed position.

10. The aquatic tank as recited in claim 1 further comprising a lighting assembly disposed in an illuminating relation relative to said interior portion of said container.

11. The aquatic tank as recited in claim 10 wherein said lighting assembly comprises at least one LED connected to an undersurface of said lid.

12. The aquatic as recited in claim 1 wherein said lid comprises a peripheral lip removably disposed in an overlapping relation with a cooperatively structured peripheral edge disposed around an open portion of said container.

13. The aquatic tank as recited in claim 1 wherein said housing is configured to be representative of an animate object.

14. The aquatic tank as recited in claim 13 wherein said housing comprises a substantially plush material.

15. The aquatic tank as recited in claim 14 wherein said housing comprises an at least partially stuffed toy.

16. The aquatic tank as recited in claim 13 wherein said housing comprises an upper head portion and a body; said lid being connected to a bottom end of said upper head portion.

17. The aquatic tank as recited in claim 16 wherein said upper head portion of said housing is removably connected to said body, and wherein removal of said upper head portion from said body simultaneously results in removal of said lid from said container.

18. The aquatic tank as recited in claim 1 further comprising an audiovisual monitoring device disposed within said housing and configured to monitor the environment external to said housing.

19. The aquatic tank as recited in claim 1 further comprising a feeding indicator structured to periodically emit a signal representative of a feeding time for the living creature disposed within said container.

20. An aquatic tank comprising:
a housing comprising a body and a removably disposed upper portion, said housing structured and configured to at least partially represent an animate object,
said body of said housing comprising a display window disposed on a predetermined portion thereof,
a container disposed within said body of said housing, said container being at least partially viewable through said display window,
said container comprising an least partially hollow interior portion dimensioned and configured to house a living creature,
a lid embedded within a bottom end of said upper portion of said housing, said lid being removably disposed relative to said container in order to allow at least temporary access into said interior portion of said container,
a plurality of at least two elongated channels each disposed within said housing, said channels being fluidically connected between said interior portion of said container and an exterior of said housing, and
a lighting assembly connected to an undersurface of said lid and disposed in an illuminating relation to interior portion of said container.

21. The aquatic tank as recited in claim 20 wherein at least one of said plurality of channels is structured and configured to facilitate a substantially continuous path of travel for a flow of air between said interior portion of said container and the exterior of said housing.

22. The aquatic tank as recited in claim 20 wherein said lid comprises a peripheral lip removably disposed in an overlapping relation with a cooperatively structured peripheral edge of said container.

23. The aquatic tank as recited in claim 22 wherein said housing comprises a substantially plush material.

24. The aquatic tank as recited in claim 22 wherein said animate object comprises a teddy bear.

25. An aquatic tank enclosure apparatus comprising:
a housing,
said housing structured and configured to at least partially represent an animate object,
said housing further comprising a body and a removably disposed upper head portion,
said body of said housing comprising a display area disposed on a predetermined portion thereof,
a container disposed at least partially within said body of said housing and being viewable through said display area,
said container comprising an least partially hollow interior portion dimensioned and configured to house a living creature,
a lid connected to a bottom end of said upper head portion of said housing, said lid being removably disposed relative to said container in order to allow at least temporary access into said interior portion of said container,
a plurality of elongated access channels disposed within said housing, said access channels being disposed in a communicative relation with said interior portion of said container,
at least one of said plurality of access channels comprising a ring cap disposed on an accessible end thereof, and
a lighting assembly connected to an undersurface of said lid and disposed in an illuminating relation to interior portion of said container.
